(19) United States
(12) Patent Application Publication
(10) Pub. No.: US 2013/0223506 A1
(43) Pub. Date: Aug. 29, 2013

(54) Flexible adaptive equalizer

(71) Applicant: BROADCOM CORPORATION, (US)

(72) Inventor: Thomas J. Kolze, Phoenix, AZ (US)

(73) Assignee: BROADCOM CORPORATION, IRVINE, CA (US)

(21) Appl. No.: 13/780,026

(22) Filed: Feb. 28, 2013

Related U.S. Application Data
(60) Provisional application No. 61/604,452, filed on Feb. 28, 2012.

(51) Int. Cl. H04L 27/01

(52) U.S. Cl. CPC H04L 27/01
USPC 375/232

(57) ABSTRACT

Flexible adaptive equalizer. Communications may be supported between two or more respective devices within a communications system via one or more available channels. Such channels may be different respective communication channels or may be logical partitions of a given communication channel. Appropriate adaptation and provision of resources within one or more devices within the system may be performed based upon any of a number of characteristics and/or considerations associated with one or more devices, channels, etc. within the system. A number of equalizer elements may be employed to perform processing of respective signal(s) received via respective channel(s). Adaptation of which equalizer elements are employed for the respective channels may be modified, adapted, etc. over time based upon any of such number of characteristics and/or considerations. Also, a number of pre-equalizer elements may also be employed to perform processing of signal(s) to be transmitted via respective channel(s).

### CROSS REFERENCE TO RELATED PATENTS/PATENT APPLICATIONS

### Provisional Priority Claims

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:

1. U.S. Provisional Patent Application Ser. No. 61/604,452, entitled “Flexible adaptive equalizer,” (Attorney Docket No. BP24581), filed Feb. 28, 2012, pending.

### BACKGROUND OF THE INVENTION

1. Technical Field of the Invention

The invention relates generally to communication systems; and, more particularly, it relates to operating one or more communication devices having multiple configuration capabilities and capable of communicating via multiple communication channels.

2. Description of Related Art

Data communication systems have been under continual development for many years. Generally speaking, communication device is limited within such systems may include a number of different modules, circuits, functional blocks, etc. therein. As the amount of circuitry and associated capability of a given device increases, generally, the overall size and associated costs that such a device similarly increases. In addition, as various communication systems seek to provide services across more and more channels, more and more streams, etc., the degree of complexity of such devices implemented within an operative within such systems similarly increases. As the number of operations to be performed per second, or the number of channels to be serviced by a given device continues to increase, the overall size, area, cost, and complexity of such devices continues to increase.

The current state-of-the-art does not provide an adequate means by which such devices may be designed and implemented to service such ever expanding and growing communication systems, including those operating to service multiple respective channels, multiple respective streams, etc. For example, as the number of respective channels to be serviced by a given device continues to increase, as well as the information rate (e.g., symbol rate was Francis increases, the current state-of-the-art does not provide an acceptable solution to meet the ever increasing desire to transmit a greater amount of information between respective devices within a system.

### BRIEF DESCRIPTION OF THE SEVERAL VIEWS OF THE DRAWINGS

FIG. 1, FIG. 2, and FIG. 3 illustrate various embodiments of communication systems.

FIG. 4 illustrates an embodiment of different respective communication devices connected and/or coupled via one or more communication channels.

FIG. 5 illustrates an alternative embodiment of different respective communication devices connected and/or coupled via one or more communication channels.

FIG. 6 illustrates an embodiment of selective switching/connectivity between one or more communication channels and one or more communication pre-equalizer and equalizers.

FIG. 7 illustrates an embodiment of multiple respective finite impulse response (FIR) filters, of equal respective lengths, that may be selective concatenated or connected to effectuate processing and/or equalization of one or more signals associated with a communication channel.

FIG. 8 illustrates an embodiment of multiple respective FIR filters, at least some of which are of diff respective lengths, that may be selective concatenated or connected to effectuate processing and/or equalization of one or more signals associated with a communication channel.

FIG. 9 illustrates an embodiment of a FIR filter employed one or more times in accordance with processing and/or equalization of one or more signals associated with a communication channel.

FIG. 10 illustrates an embodiment of multiple respective FIR filters each respectively employed one or more times in accordance with processing and/or equalization of one or more signals associated with a communication channel.

FIG. 11, FIG. 12, FIG. 13, and FIG. 14 illustrate various embodiments of methods for operating one or more communication devices.

### DETAILED DESCRIPTION OF THE INVENTION

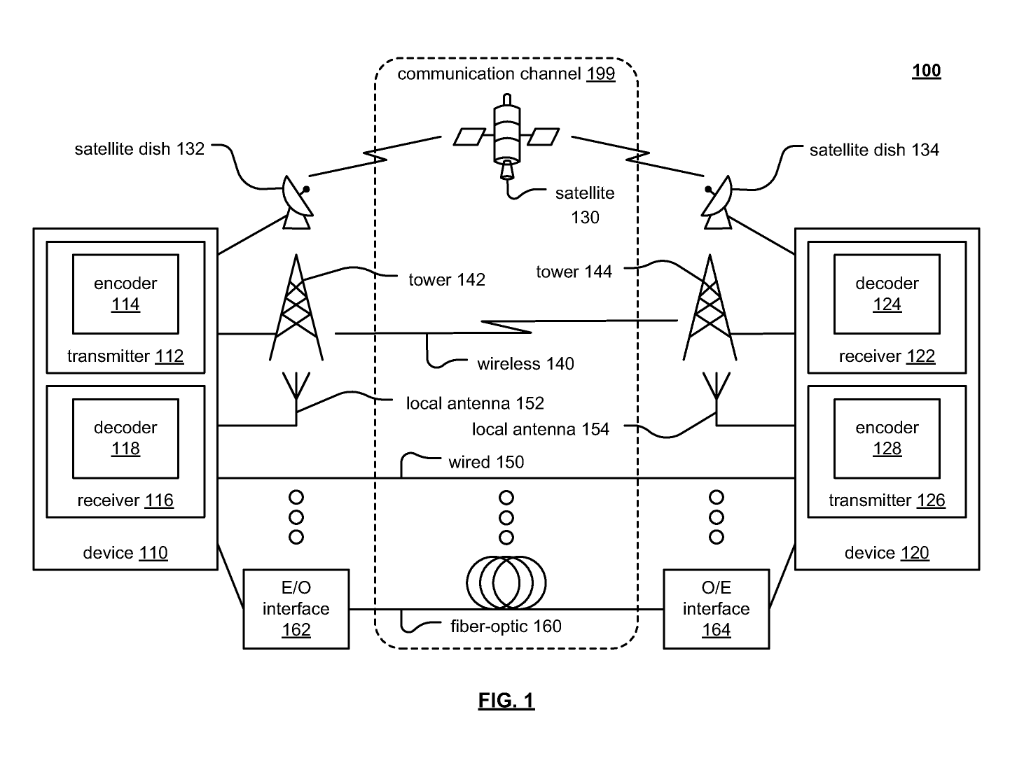

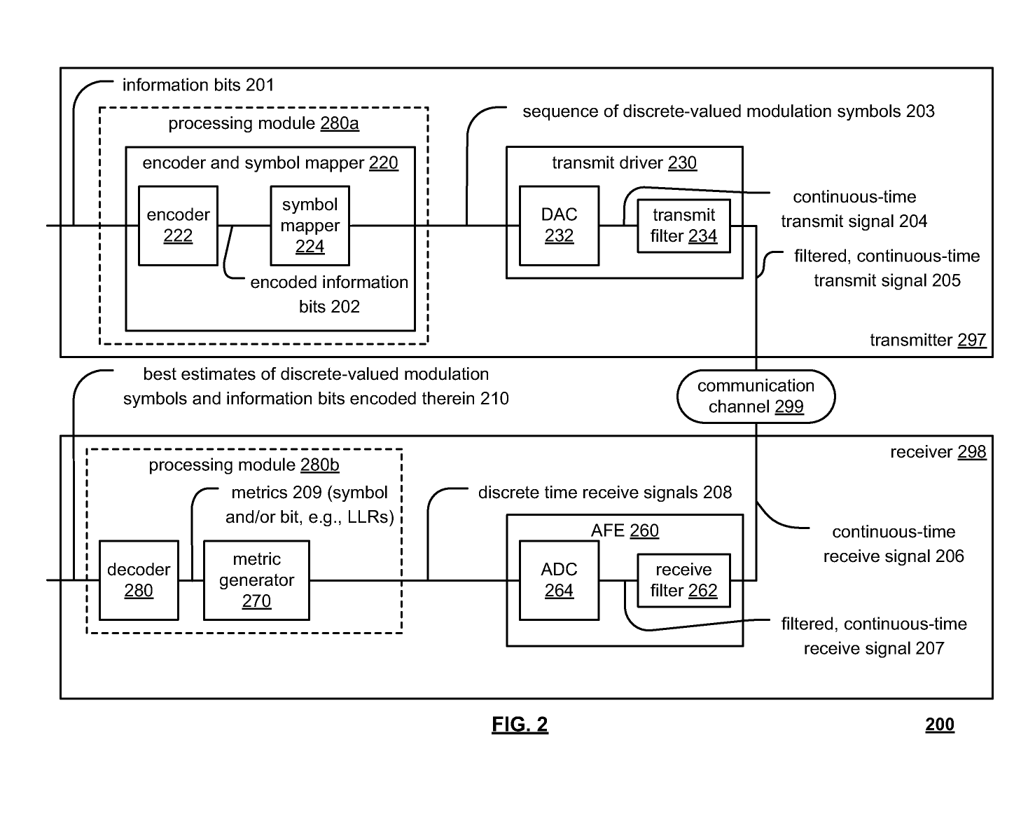

Within communication systems, signals are transmitted between various communication devices therein. The goal of digital communications systems is to transmit digital data from one location, or subsystem, to another either error free or with an acceptably low error rate. As shown in FIG. 1, data may be transmitted over a variety of communications channels in a wide variety of communication systems: magnetic media, wired, wireless, fiber, copper, and other types of media as well.

FIG. 1 and FIG. 2 are diagrams illustrate various embodiments of communication systems, 100 and 200, respectively.

Referring to FIG. 1, this embodiment of a communication system 100 is a communication channel 199 that communicatively couples a communication device 110 (including a transmitter 112 having an encoder 114 and including a receiver 116 having a decoder 118) situated at one end of the communication channel 199 to another communication device 120 (including a transmitter 126 having an encoder 128 and including a receiver 122 having a decoder 124) at the other end of the communication channel 199. In some embodiments, either of the communication devices 110 and 120 may only include a transmitter or a receiver. There are several different types of media by which the communication channel 199 may be implemented (e.g., a satellite communication channel 130 using satellite dishes 132 and 134, a wireless communication channel 140 using towers 142 and 144 and/or local antennae 152 and 154, a wired communication channel 150, and/or a fiber-optic communication channel 160 using electrical to optical (E/O) interface 162 and optical to electrical (O/E) interface 164)). In addition, more than one type of media may be implemented and interfaced together thereby forming the communication channel 199.

To reduce transmission errors that may undesirably be incurred within a communication system, error correction and channel coding schemes are often employed. Generally, these error correction and channel coding schemes involve the use of an encoder at the transmitter end of the communication channel 199 and a decoder at the receiver end of the communication channel 199.

Any of various types of ECC codes described can be employed within any such desired communication system (e.g., including those variations described with respect to FIG. 1), any information storage device (e.g., hard disk drives (HDDs), network information storage devices and/or servers, etc.) or any application in which information encoding and/or decoding is desired.

Generally speaking, when considering a communication system in which video data is communicated from one location, or subsystem, to another, video data encoding may generally be viewed as being performed at a transmitting end of the communication channel 199, and video data decoding may generally be viewed as being performed at a receiving end of the communication channel 199.

Also, while the embodiment of this diagram shows bi-directional communication being capable between the communication devices 110 and 120, it is of course noted that, in some embodiments, the communication device 110 may include only video data encoding capability, and the communication device 120 may include only video data decoding capability, or vice versa (e.g., in a uni-directional communication embodiment such as in accordance with a video broadcast embodiment).

It is noted that such communication devices 110 and/or 120 may be stationary or mobile without departing from the scope and spirit of the invention. For example, either one or both of the communication devices 110 and 120 may be implemented in a fixed location or may be a mobile communication device with capability to associate with and/or communicate with more than one network access point (e.g., different respective access points (APs) in the context of a mobile communication system including one or more wireless local area networks (WLANs), different respective satellites in the context of a mobile communication system including one or more satellite, or generally, different respective network access points in the context of a mobile communication system including one or more network access points by which communications may be effectuated with communication devices 110 and/or 120.

Referring to the communication system 200 of FIG. 2, at a transmitting end of a communication channel 299, information bits 201 (e.g., corresponding particularly to video data in one embodiment) are provided to a transmitter 297 that is operable to perform encoding of these information bits 201 using an encoder and symbol mapper 220 (which may be viewed as being distinct functional blocks 222 and 224, respectively) thereby generating a sequence of discrete-valued modulation symbols 203 that is provided to a transmit driver 230 that uses a DAC (Digital to Analog Converter) 232 to generate a continuous-time transmit signal 204 and a transmit filter 234 to generate a filtered, continuous-time transmit signal 205 that substantially comports with the communication channel 299. At a receiving end of the communication channel 299, continuous-time receive signal 206 is provided to an AFE (Analog Front End) 260 that includes a receive filter 262 (that generates a filtered, continuous-time receive signal 207) and an ADC (Analog to Digital Converter) 264 (that generates discrete-time receive signals 208). A metric generator 270 calculates metrics 209 (e.g., on either a symbol and/or bit basis) that are employed by a decoder 280 to make best estimates of the discrete-valued modulation symbols and information bits encoded therein 210.

Within each of the transmitter 297 and the receiver 298, any desired integration of various components, blocks, functional blocks, circuitries, etc. Therein may be implemented. For example, this diagram shows a processing module 280a as including the encoder and symbol mapper 220 and all associated, corresponding components therein, and a processing module 280 is shown as including the metric generator 270 and the decoder 280 and all associated, corresponding components therein. Such processing modules 280a and 280b may be respective integrated circuits. Of course, other boundaries and groupings may alternatively be performed without departing from the scope and spirit of the invention. For example, all components within the transmitter 297 may be included within a first processing module or integrated circuit, and all components within the receiver 298 may be included within a second processing module or integrated circuit. Alternatively, any other combination of components within each of the transmitter 297 and the receiver 298 may be made in other embodiments.

As with the previous embodiment, such a communication system 200 may be employed for the communication of video data is communicated from one location, or subsystem, to another (e.g., from transmitter 297 to the receiver 298 via the communication channel 299).

Referring to the communication system 300 of FIG. 3, this communication system 300 may be viewed particularly as being a cable system. Such a cable system may generally be referred to as a cable plant and may be implemented, at least in part, as a hybrid fiber-coaxial (HFC) network (e.g., including various wired and/or optical fiber communication segments, light sources, light or photo detection complements, etc.). For example, the communication system 300 includes a number of cable modems (shown as CM 1, CM 2, and up to CM n). A cable modem network segment 399 couples the cable modems to a cable modem termination system (CMTS) (shown as 340 or 340a and as described below).

A CMTS 340 or 340a is a component that exchanges digital signals with cable modems on the cable modem network segment 399. Each of the cable modems coupled to the cable modem network segment 399, and a number of elements may be included within the cable modem network segment 399. For example, routers, splitters, couplers, relays, and amplifiers may be contained within the cable modem network segment 399.

The cable modem network segment 399 allows communicative coupling between a cable modem (e.g., a user) and the cable headend transmitter 330 and/or CMTS 340 or 340a. Again, in some embodiments, a CMTS 340a is in fact contained within a cable headend transmitter 330. In other embodiments, the CMTS is located externally with respect to the cable headend transmitter 330 (e.g., as shown by CMTS 340). For example, the CMTS 340 may be located externally to the cable headend transmitter 330. In alternative embodiments, a CMTS 340a may be located within the cable headend transmitter 330. The CMTS 340 or 340a may be located at a local office of a cable television company or at another location within a cable system. In the following description, a CMTS 340 is used for illustration; yet, the same functionality and capability as described for the CMTS 340 may equally apply to embodiments that alternatively employ the CMTS 340a. The cable headend transmitter 330 is able to provide a number of services including those of audio, video, local access channels, as well as any other service of cable systems. Each of these services may be provided to the one or more cable modems (e.g., CM 1, CM 2, etc.). In addition, it is noted that the cable headend transmitter 330 may provide any of these various cable services via cable network segment 398 to a set top box (STB) 320, which itself may be coupled to a television 310 (or other video or audio output device). While the STB 320 receives information/services from the cable headend transmitter 330, the STB 320 functionality may also support bi-directional communication, in that, the STB 320 may independently (or in response to a user's request) communicate back to the cable headend transmitter 330 and/or further upstream.

In addition, through the CMTS 340, the cable modems are able to transmit and receive data from the Internet and/or any other network (e.g., a wide area network (WAN), internal network, etc.) to which the CMTS 340 is communicatively coupled. The operation of a CMTS, at the cable-provider's head-end, may be viewed as providing analogous functions provided by a digital subscriber line access multiplexor (DSLAM) within a digital subscriber line (DSL) system. The CMTS 340 takes the traffic coming in from a group of customers on a single channel and routes it to an Internet Service Provider (ISP) for connection to the Internet, as shown via the Internet access. At the head-end, the cable providers will have, or lease space for a third-party ISP to have, servers for accounting and logging, dynamic host configuration protocol (DHCP) for assigning and administering the Internet protocol (IP) addresses of all the cable system's users (e.g., CM 1, CM2, etc.), and typically control servers for a protocol called Data Over Cable Service Interface Specification (DOCSIS), the major standard used by U.S. cable systems in providing Internet access to users. The servers may also be controlled for a protocol called European Data Over Cable Service Interface Specification (EuroDOCSIS), the major standard used by European cable systems in providing Internet access to users, without departing from the scope and spirit of the invention.

The downstream information flows to all of the connected cable modems (e.g., CM 1, CM2, etc.). The individual network connection, within the cable modem network segment 399, decides whether a particular block of data is intended for it or not. On the upstream side, information is sent from the cable modems to the CMTS 340; on this upstream transmission, the users within the group of cable modems to whom the data is not intended do not see that data at all. As an example of the capabilities provided by a CMTS, a CMTS will enable as many as 1,000 users to connect to the Internet through a single 6 Mega-Hertz channel. Since a single channel is capable of 30-40 Mega-bits per second of total throughput (e.g., currently in the DOCSIS standard, but with higher rates envisioned such as those sought after in accordance with the developing DVB-C2 (Digital Video Broadcasting—Second Generation Cable) standard, DVB-T2 (Digital Video Broadcasting—Second Generation Terrestrial) standard, etc.), this means that users may see far better performance than is available with standard dial-up modems.

Moreover, it is noted that the cable network segment 398 and the cable modem network segment 399 may actually be the very same network segment in certain embodiments. In other words, the cable network segment 398 and the cable modem network segment 399 need not be two separate network segments, but they may simply be one single network segment that provides connectivity to both STBs and/or cable modems. In addition, the CMTS 340 or 340a may also be coupled to the cable network segment 398, as the STB 320 may itself include cable modem functionality therein.

It is also noted that any one of the cable modems 1, 2, . . . m n, the cable headend transmitter 330, the CMTS 340 or 340a, the television 310, the STB 320, and/or any device existent within the cable network segments 398 or 399, may include a memory optimization module as described herein to assist in the configuration of various modules and operation in accordance with any one of a plurality of protocols therein.

Various communication devices can operate by employing an equalizer therein (e.g., an adaptive equalizer). Some examples of such communication devices include those described herein, including cable modems (CMs). However, it is noted that various aspects and principles presented herein may be generally applied to any type of communication device located within any of a variety of types of communication systems. For example, while some illustrative and exemplary embodiments herein employ the use of a CM in particular, though it is noted that such aspects and principles presented herein may be generally applied to any type of communication device located within any of a variety of types of communication systems.

Various communication devices (e.g., a cable modem (CM), a cable modem termination system (CMTS), etc.) may report information there between and coordinate operation thereof.

It is again noted that while the particular illustrative example of a cable modem (CM) is employed in a number of different embodiments, diagrams, etc. herein, such architectures, functionality, and/or operations may generally be included and/or performed within any of a number of various types of communication devices including those operative in accordance with the various communication system types, including those having more than one communication medium type therein, such as described with reference to FIG. 1.

Generally speaking, certain communication devices may be implemented to receive signals from or provide signals to communication networks or communication systems having more than one respective communication channel. In addition, in certain situations, a given communication channel may be subdivided respectfully into a number of communication channels (e.g., either different respective communication channels, such as different respective frequency bands within a given communication channel, or even within different respective logical communication channels). Generally, as the symbol rate to be supported by a given communication channel scales, for an equalizer to be able to cover such a signal having a modified symbol rate, that equalizer would have to scale accordingly. For example, considering an example in which the symbol rate of a signal scales by a factor of n, then for the amount of delay spread a corresponding equalizer would need to cover to stay the same would require that the equalizer would generally need to have n times the number of respective taps. In one particular implementation, as the symbol rate of the signal scales by a factor of 4, then the number of equalizer taps that would be required would be {4×(n−1)}+1=4×n+3.

In terms of complexity in regards to the size, real estate, surface area, etc. (e.g., alternatively referred to as the squaring complexity cost in terms of symbol rate) required to implement an equalizer within a communication device, the complexity costs associated with the modification in symbol rate comes from the number of multiplies performed per second (or per unit time) which much be implemented for the equalizer. For example, for an equalizer to operate at approximately n times speed, when the symbol rate is increased by a factor of n, then the equalizer would need (approximately) n times the total number of taps to be equivalent.

Moreover, with respect to communication device is implemented within systems having more than one communication channel (e.g., either actual, subdivided, logical, etc.), The multiplication of the complexity of an equalizer increases as a square with respect to the symbol rate on a per channel basis. In terms of an increasing complexity cost for operating within a given bandwidth, the complexity cost is linear in increase in terms of equalizer multiplies per second (or per unit time) with an increase in symbol rate, on a per Hertz (Hz) basis. In terms of cost comparison between respective devices in regards to the size, real estate, service area, complexity, etc., the complexity cost may be referred to as being linear in increase in terms of equalizer multiplies per second (or per unit time) with an increase in symbol rate, on a per Hertz (Hz) basis.

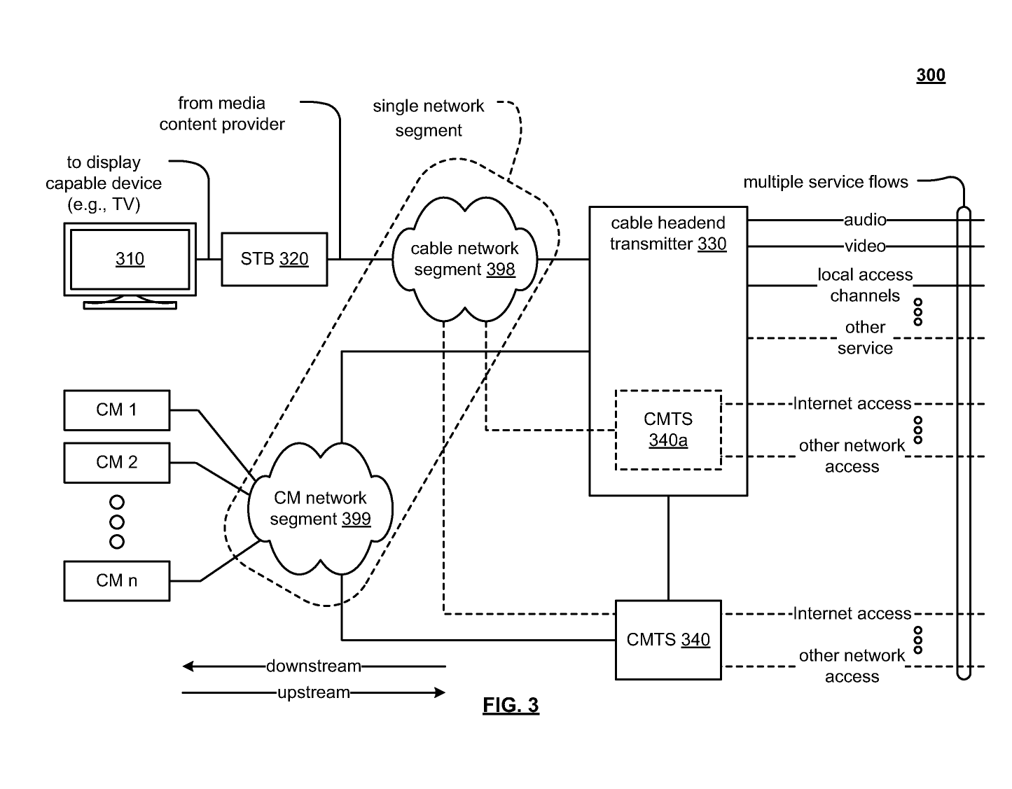

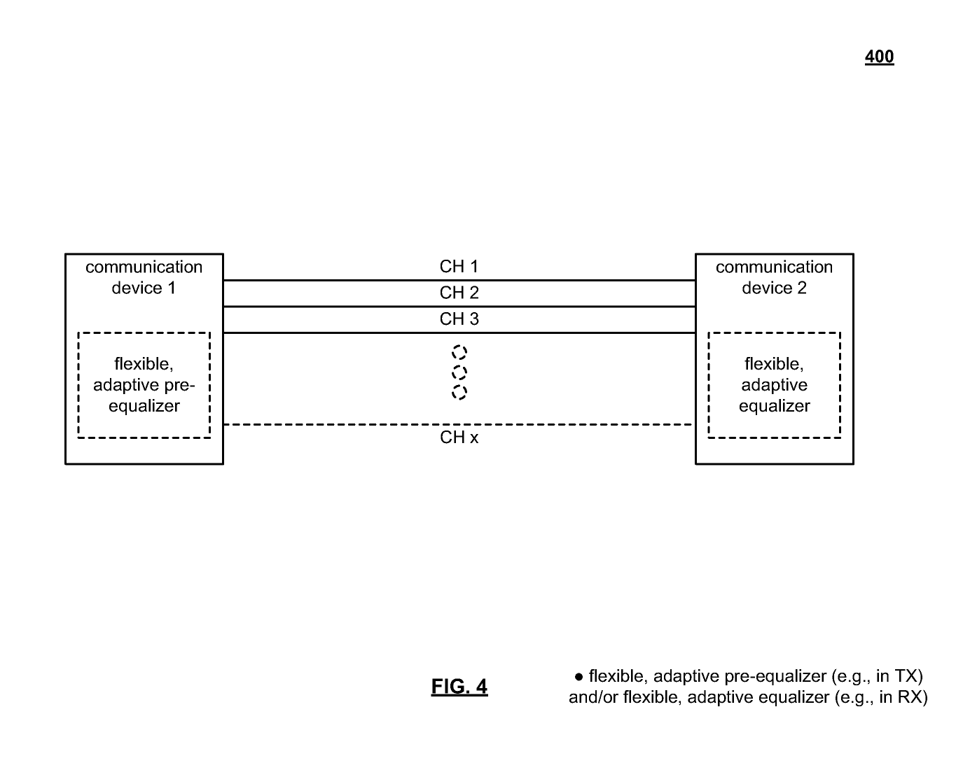

FIG. 4 illustrates an embodiment 400 of different respective communication devices connected and/or coupled via one or more communication channels. As may be seen with respect to this diagram, different respective communication devices may be connected and/or coupled via one or more communication channels which may correspond to one or more communication systems, networks, network segments, etc.

In certain embodiments, a flexible, adaptive pre-equalizer is implemented within a communication device to effectuate pre-equalization processing of one or more signals to be transmitted via one or more communication channels. In other embodiments, a flexible, adaptive equalizer is implemented within a communication device to effectuate equalization processing one or more signals received from one or more communication channels. Of course, it is noted that a given communication device having transceiver capability could include both a flexible, adaptive pre-equalizer (e.g., for transmitter associated operations) and a flexible, adaptive, adaptive equalizer (e.g., for receiver associated operations) without departing from the scope and spirit of the invention.

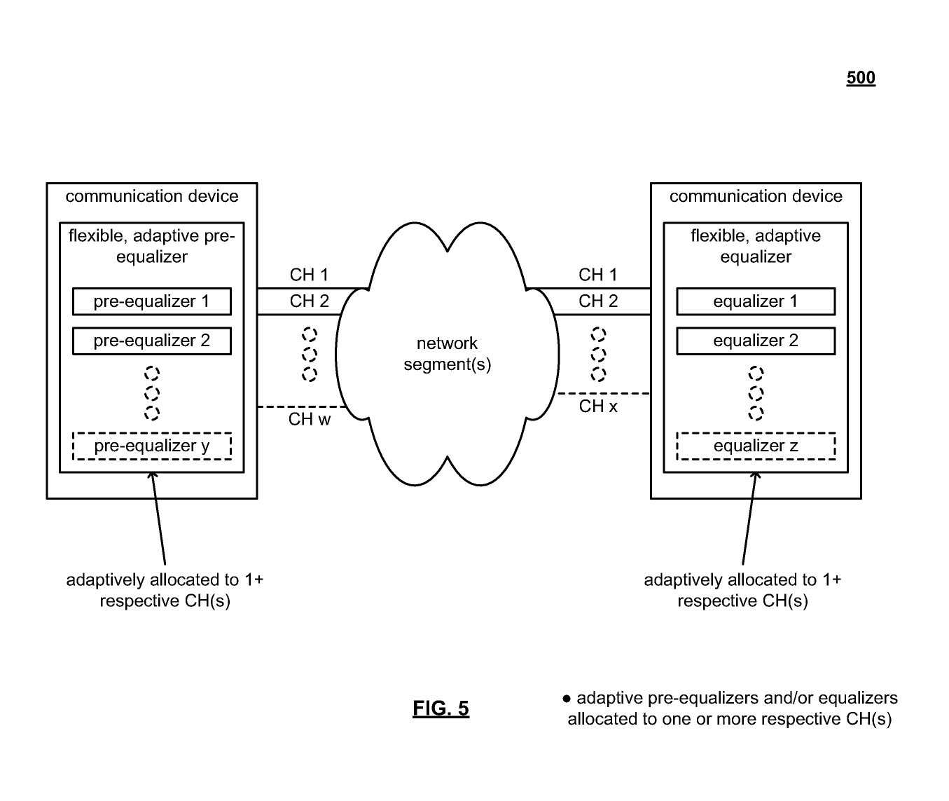

FIG. 5 illustrates an alternative embodiment 500 of different respective communication devices connected and/or coupled via one or more communication channels. As may be seen with respect to this diagram, different respective communication devices may be connected and/or coupled via one or more communication channels which may correspond to one or more communication systems, networks, network segments, etc.

Referring to this particular diagram, it can be seen that a flexible, adaptive pre-equalizer (which may be implemented within any desired communication device) may be implemented that includes a number of different respective pre-equalizer modules, circuitries, functional blocks, or other respective components. Analogously, it can be seen that a flexible, adaptive equalizer (which may be implemented within any desired communication device) may be implemented that includes a number of different respective equalizer modules, circuitries, functional blocks, elements, or other respective components. Generally speaking, such pre-equalizer or equalizer modules, circuitries, functional blocks, elements, or other respective components may be referred to as pre-equalizer elements or equalizer elements.

Such an architecture which may be implemented with respect to either a flexible, adaptive pre-equalizer or equalizer will include a number of respective modules, circuitries, functional blocks, elements, or other respective components each respectively including adaptive equalizer or per equalizer taps, machinery, etc. Any desired number of pre-equalizer elements and/or equalizer elements may be implemented within any given device. As stated with respect other diagrams and/or embodiments herein, it is of course noted that both a flexible, adaptive pre-equalizer and a flexible, adaptive equalizer may be implemented within a singular device (e.g., a device may include both an embodiment of a pre-equalizer and an equalizer in accordance with the subject matter as claimed by the Applicant).

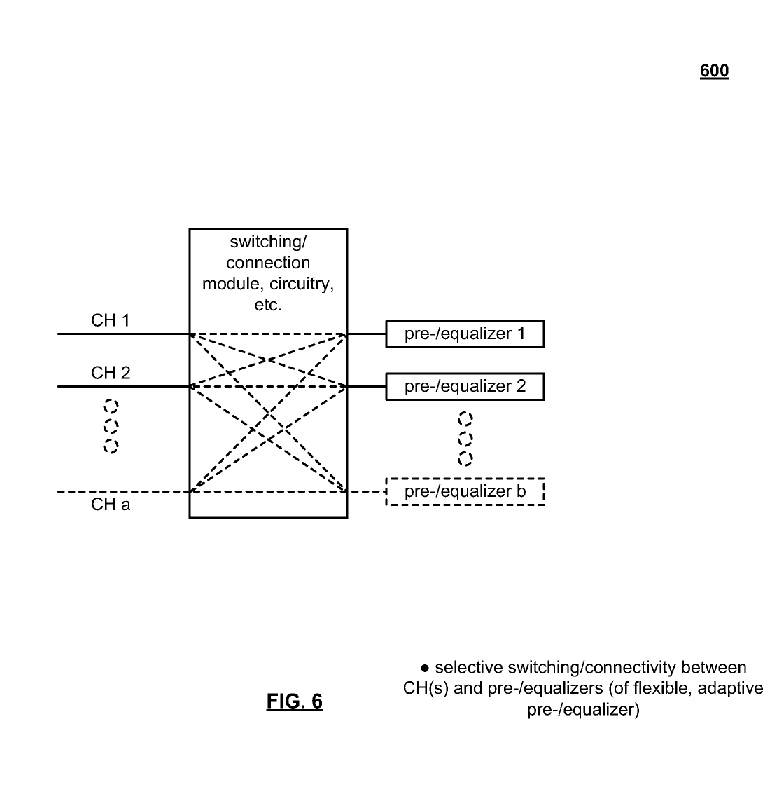

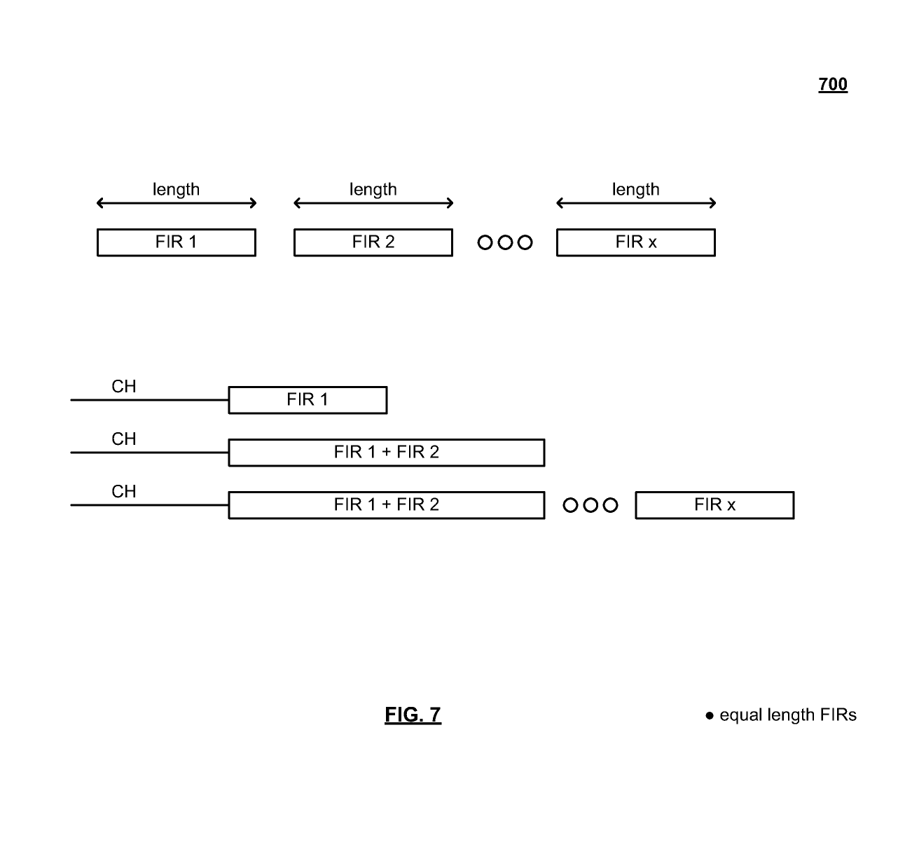

FIG. 6 illustrates an embodiment 600 of selective switching/connectivity between one or more communication channels and one or more communication pre-equalizer and equalizers. As may be seen with respect to this diagram, any desired connectivity between a number of pre-equalizers or equalizers may be made with respect to performing processing of signals corresponding to one or more respective communication channels. For example, all of the pre-equalizers or equalizers may be employed to perform processing of a signal corresponding to any one of the respective communication channels. In addition, as few as one or any desired subset of the pre-equalizers or equalizers may alternatively be employed to perform processing of a signal corresponding to any one of the respective communication channels.

Generally speaking, such an adaptable architecture allowing for switching/connection of any respective pre-equalizer or equalizer elements, including all of the respective pre-equalizer or equalizer elements and including any desired subset of the pre-equalizer or equalizer elements, will allow for stringing together and concatenation of a number of respective desired types of pre-equalization or equalization. For example, such flexibility of switching/connection of any desired group of one or more pre-equalizer or equalizer elements will allow for adaptation with respect to processing of signals corresponding to one or more communication channels. For example, different respective amounts and degrees of pre-equalization or equalization may be selectively applied to one or more signals corresponding to one or more communication channels. Adaptive application of these respective pre-equalizer equalizer elements will allow for the treatment of different respective signals, respective portions of the spectrum of one or more signals, etc. being handled differently.

For example, two respective exemplary case examples are provided below to illustrate such adaptation.

Case 1:

16 channels of 5.12 mega symbols per second upstream channels (e.g., DOCSIS upstream channels) for 16 channels×6.4 MHz per channel=102.4 megahertz of upstream bandwidth

Case 2:

4 channels of 20.48 mega symbols per second upstream channels (e.g., DOCSIS upstream channels) for 4 channels×25.6 MHz per channel=102.4 megahertz of upstream bandwidth

If Case 1 requires 24 equalizer taps per channel, then it may be reasonably expected that Case 2 requires 96 equalizer taps (e.g., generally or approximately to cover the same delay spread in the impulse response).

Therefore, on a per channel basis, such a pre-equalizer or equalizer grows linearly (generally) with symbol rate in terms of the number of taps required per channel. However, to occupy the same bandwidth, the number of equalizer taps is unchanged from Case 1 to Case 2.

As may be understood with respect to the scaling of the area, real estate, complexity, etc. of a pre-equalizer or equalizer in order to accommodate an increase in symbol rate by a factor of n will also be generally around the factor of n. However, it may also be noted that regardless of the number of channels it may take to occupy a given bandwidth, the respective area, real estate, complexity, etc. of a pre-equalizer or equalizer is nonetheless the same. For example, if “area, real estate” is described as being correspondingly related to a measure of “complexity”, then the pre-equalizer or equalizer complexity is nonetheless unchanged even if the symbol rate is scaled by a factor of n. As may be seen, such a “squared” growth factor for per channel “multiplies per second” may be viewed as becoming a linear growth factor in comparing Case 1 and Case 2 four multiplies per second (e.g., for equalization or pre-equalization). In other words, in terms of “area, real estate” (such as that employed with respect to a measure of “complexity”), Case 1 and Case 2 may be viewed as being equivalent (e.g., such as in terms of area, real estate, required for performing pre-equalization or equalization because each respective implementation includes a same total number of taps.

As may be understood, the flexibility provided by different respective pre-equalizer or equalizer elements allows for adaptation in a number of ways. By employing such an adaptive and flexible architecture, they respective chips of the signal (e.g., such as in accordance with a code division multiple access (CDMA) signal, or a synchronous-CDMA (S-CDMA) signal, etc.) may be apportioned a respective number of pre-equalizer equalizer taps, and they may be used for Case 1 in one embodiment or alternatively switched/connected differently (e.g., perhaps employing fewer respective groups of longer strings of pre-equalizer or equalizer taps) for use in an embodiment such as Case 2.

In addition, these respective taps may also be employed in such a way as to assign more of them to lower and or upper band-edge regions (e.g., such as those respective regions impacted by roll-off filtering), thereby leaving the middle portion of the spectrum to be processed or using fewer respective taps per channel than the band-edge channels. In other words, adaptation with respect to different respective portions of the frequency spectrum corresponding to multiple respective channels may be made.

As may be understood, such an architecture (for either pre-equalization or equalization) allows for the grouping or concatenation of different respective such elements each respectively including one or more equalizer taps (and each respective element may include different respective numbers of equalizer taps in certain embodiments). The grouping or concatenation of such elements may be made adaptively to allow for dynamic and adaptive application of different respective amounts and degrees of pre-equalization or equalization two different respective signals corresponding to different respective communication channels.

For example, referring again to the Case 1 and the Case 2 described above, Case 1 could include the respective elements concatenated or connected in one particular manner and Case 2 could include those same respective elements concatenated or connected in another particular manner (e.g., such as including fewer groups of longer strings of elements). As may be noted with respect to the dynamic and flexible operation with respect to two different cases (e.g., Case 1 and Case 2), it is of course noted that any desired number of different respective cases may be accommodated by adaptively concatenating or connecting the available elements or any desired subset thereof in different respective ways. Again, employing the respective taps of these respective elements in such a way as to assign more of them to lower and upper band-edge regions (e.g., such as those relatively more impacted by roll-off filtering) may be performed thereby leaving the middle portion of the frequency spectrum using relatively fewer taps per channel than the band-edge channels.

In addition, in an embodiment that may have a number of respective channels with relatively similar delay spread characteristics but with different respective signal to noise ratios (SNRs) (e.g., perhaps due to ingress, signal power, transmit signal power limitations and increased propagation path attenuation at some frequencies, or increased insertion loss from any reason at different frequencies impacting signal power differently than aggregate in in-band power at a receiver, etc.), then relatively fewer equalizer taps may be required at those respective channels having relatively lower SNR in certain situations. Generally, it is beneficial to use more equalizer taps in order to capture more of the delay spread of the channel impulse response, such as when signal constellation density increases such as may be associated with switching to a relatively more robust modulation scheme (having relatively fewer constellation points, for example), which generally occurs in higher SNR channels that can adapt their respective modulation schemes to current operating conditions (e.g., DOCSIS).

Since certain communication standards, protocols, and a recommended practices (e.g., DOCSIS) can adapt the respective modulation to best use an upstream resource for any of a variety of criteria, leveraging the capability associated with flexible adaptive equalizer length, a receiver communication device may be adaptively configured with different respective numbers of taps provisioned respectively for different respective communication channels (e.g., until all of the pre-equalizer or equalizer taps are assigned) with such assignment of pre-equalizer or equalizer capability based upon any of a number of considerations such as, but not limited to, modulation constellation density, allowable error rates, error correction coding, thermal noise, signal strength, ingress, SNR, carrier to noise ratio (CNR), carrier to noise plus interference or ingress ratio (CNIR), etc. and/or any other respective factor(s). Any one or more of such factors may be employed to direct and drive the dynamic adjustment and/or adaptive application of the respective pre-equalizer or equalizer elements, including the respective taps thereof, in a flexible communication device architecture. In addition, any of a number of alternative metrics corresponding to signals generated after some ingress cancellation or ingress mitigation is employed may similarly be used.

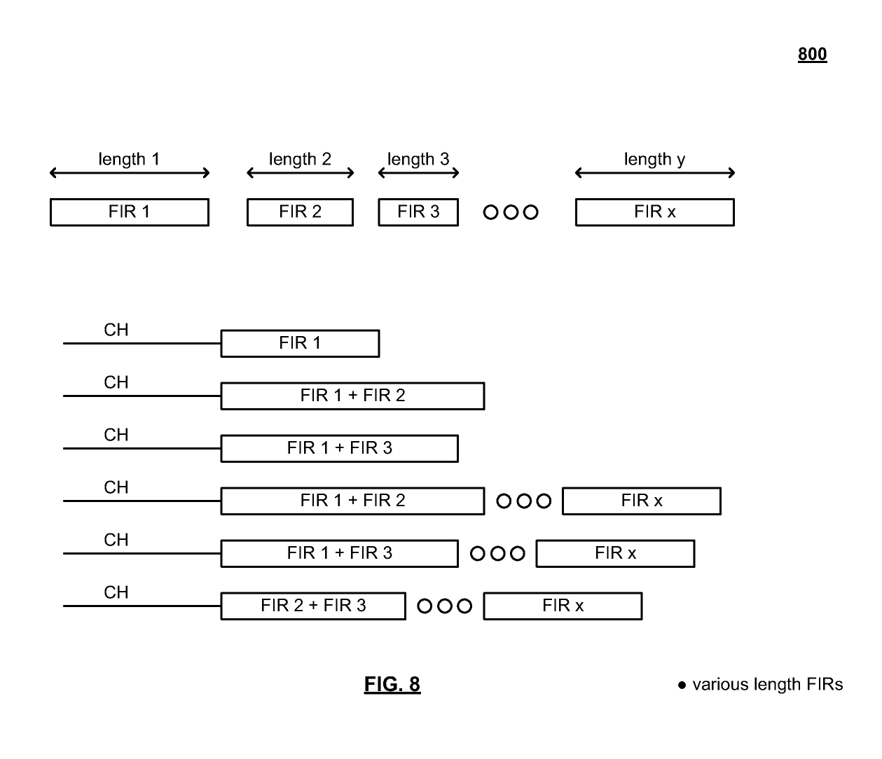

FIG. 7 illustrates an embodiment 700 of multiple respective finite impulse response (FIR) filters, of equal respective lengths, that may be selective concatenated or connected to effectuate processing and/or equalization of one or more signals associated with a communication channel. As may be seen with respect to this diagram, a number of respective FIR filters are implemented within a device. A signal corresponding to a given communication may be processed using any desired group of the FIR filters, including as few as one of the FIR filters, any desired subset of the FIR filters, or all of the respective FIR filters as may be desired in a particular embodiment. In this diagram, the respective length of each of the FIR filters is shown as being the same.

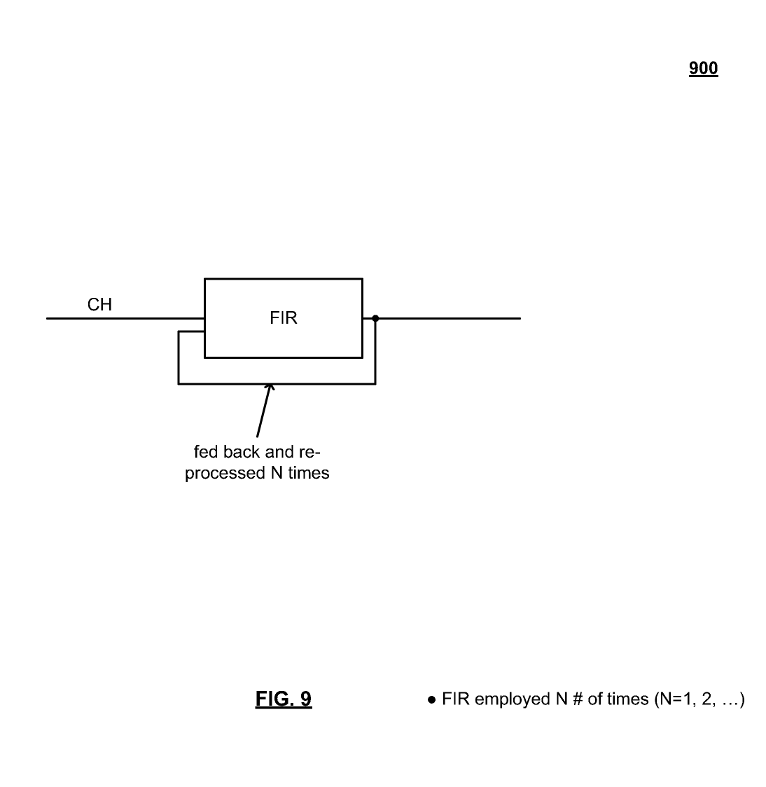

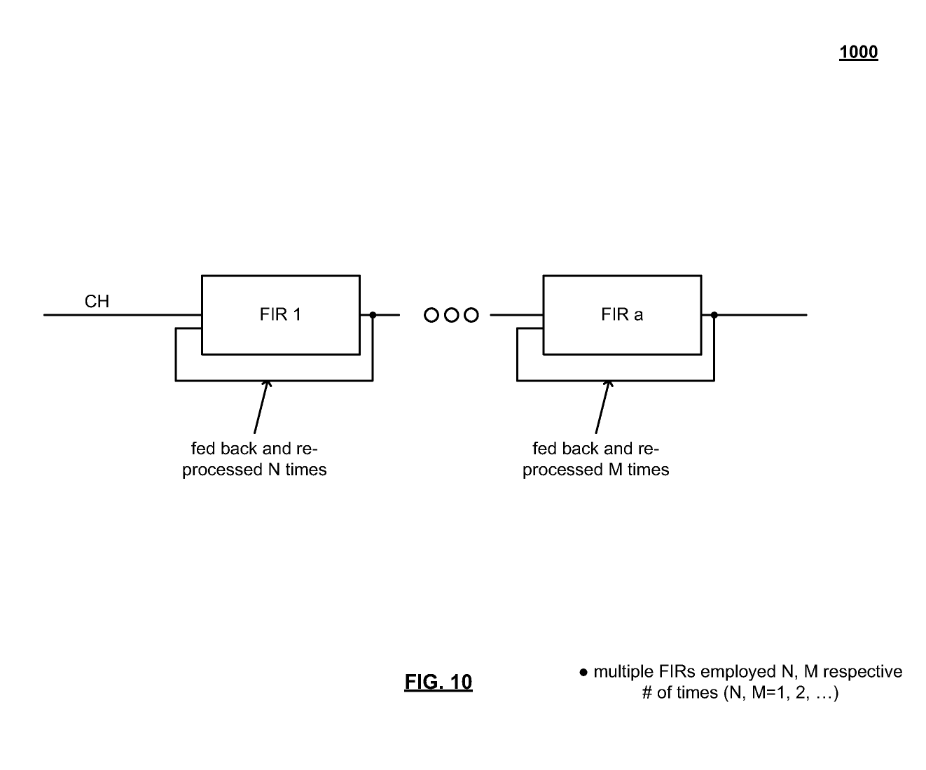

FIG. 8 illustrates an embodiment 800 of multiple respective FIR filters, at least some of which are of diff respective lengths, that may be selective concatenated or connected to effectuate processing and/or equalization of one or more signals associated with a communication channel. Analogous to the previous diagram, a number of respective FIR filters are implemented within a device. However, in this diagram, the respective lengths of each of the FIR filters need not necessarily be the same. Of course, two or more respective FIR filters may in fact be of the same length, but generally, any desired number of FIR filters respectively having any desired lengths may be implemented within a device. A signal corresponding to a given communication channel may be processed using any desired group of the FIR filters including as few as one of the FIR filters, any desired subset of the FIR filters, or all of the respective FIR filters as may be desired in a particular embodiment. However, in comparing this particular diagram with the previous diagram, given that the FIR filters of this particular diagram are not necessarily of the same length, any desired degree of combination of as few as one or two or more FIR filters may be made to effectuate processing using various desired numbers of taps. By including a number of FIR filters having different respective lengths, a great degree of variability and flexibility may be provided in regards to the various combinations of lengths of taps that may be combined or concatenated for use in processing a signal corresponding to a communication channel.

With respect to any of the various embodiments and/or diagrams herein, it is noted that various means may be employed to select the equalizer tap coefficients to be employed within any of the equalizers, filters, pre-equalizer's, etc. For example, in some instances, a given device may include a processor to perform a least means square (LMS) optimization process to select the equalizer coefficients corresponding to one or more of the equalizer elements. Analogously, such an LMS optimization process may be employed to select any desired operational parameters or values to be employed by the various modules, functional blocks, circuitries, components, elements, etc. within any of the various devices in accordance with any one or more of the various aspects, embodiments, and/or their equivalents, of the invention. In addition, it is noted that real-time adaptation may be performed as well, such that any operational parameter may be modified or changed over time. Moreover, a first set of operational parameters may be employed at a first time, and a second set of operational parameters may be employed at a second time, even if the air are different respective numbers of operational parameters within the different respective sets of operational parameters. Of course, any one particular operational parameter may be modified over time as well.

Various considerations which may be employed to direct the selection, modification, change, etc. of any such operational parameters may be one or more characteristics associated with one or more communication channels by which a given device communicates with one or more other communication devices. Various examples of such characteristics may include, but are not limited to, latency, delay, noise, distortion, crosstalk, attenuation, signal to noise ratio (SNR), capacity, bandwidth, frequency spectrum, bit rate, and symbol rate associated with at least one the communication channels by which a given device communicates with one or more other communication devices. In addition, various other considerations may be employed including environmental considerations (e.g., temperature, humidity, pressure, etc. and/or any change of any such environmental consideration), any local operating condition including operational history such as prior operational state or status, current operational state or status, etc. any remote operating condition as associated with one or more devices, components, circuitries, etc. that is remote with respect to a given device, circuitry, etc. Generally, as may be understood with respect to the communications system including at least two respective communication devices that may communicate their between using one or more respective communication channels (e.g., as described with various diagrams and/or embodiments herein, and associated written description), information corresponding to any one or more of the respective elements within such a system may be used, at least in part, as a basis by which such operational parameters may be selected, modified, adapted, etc.

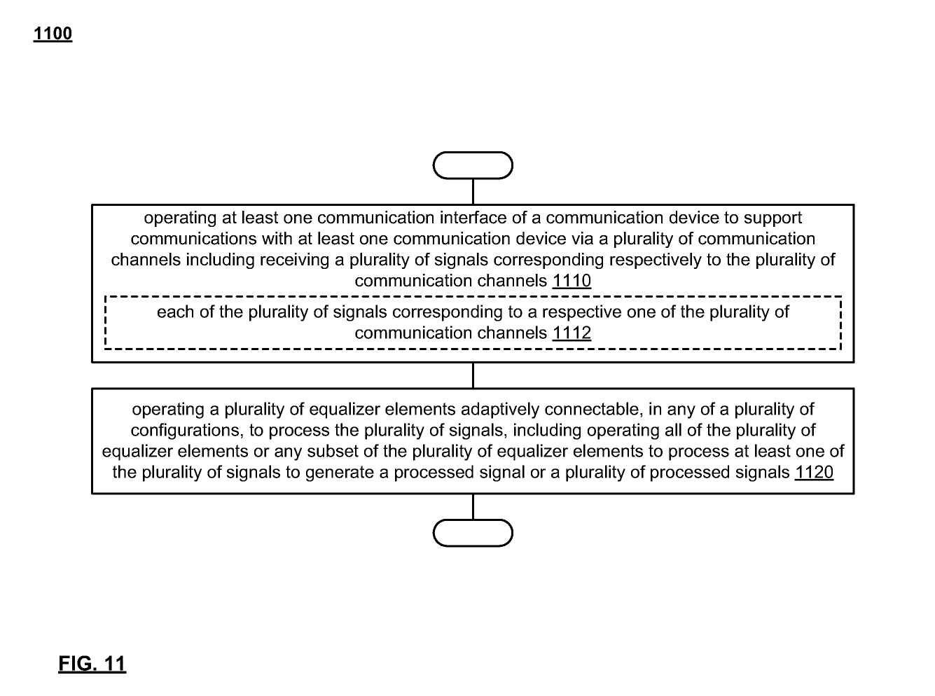

FIG. 9 illustrates an embodiment 900 of a FIR filter employed one or more times in accordance with processing and/or equalization of one or more signals associated with a communication channel. As may be seen with respect to this diagram, as few as one FIR filter may be implemented such that the FIR filter may perform successive processing of respectively generated signals. For example, a signal corresponding to a communication channel may undergo first processing by the FIR filter thereby generating a processed signal. This processed signal may then be fed back and re-processed using the very same FIR filter. The number of times that a signal may undergo processing may be adaptively selected. As may be understood with respect to this diagram, by performing successive processing of a signal, and the intervening and intermediate versions generated by such FIR filter processing, different respective numbers of taps may be applied to the processing of a given signal by reusing the same FIR filter.

For example, there may be some embodiments in which a device may operate at a relatively lower speed, and the successive re-processing of a signal, in the intervening and intermediate versions thereof, may be performed multiple respective times.

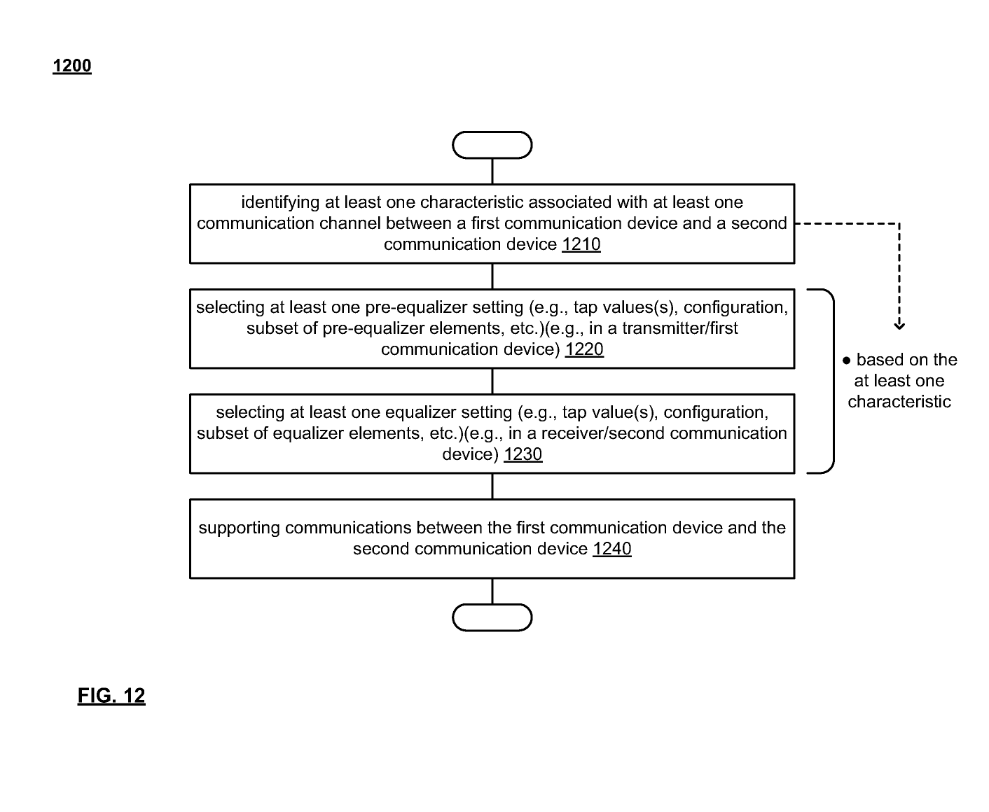

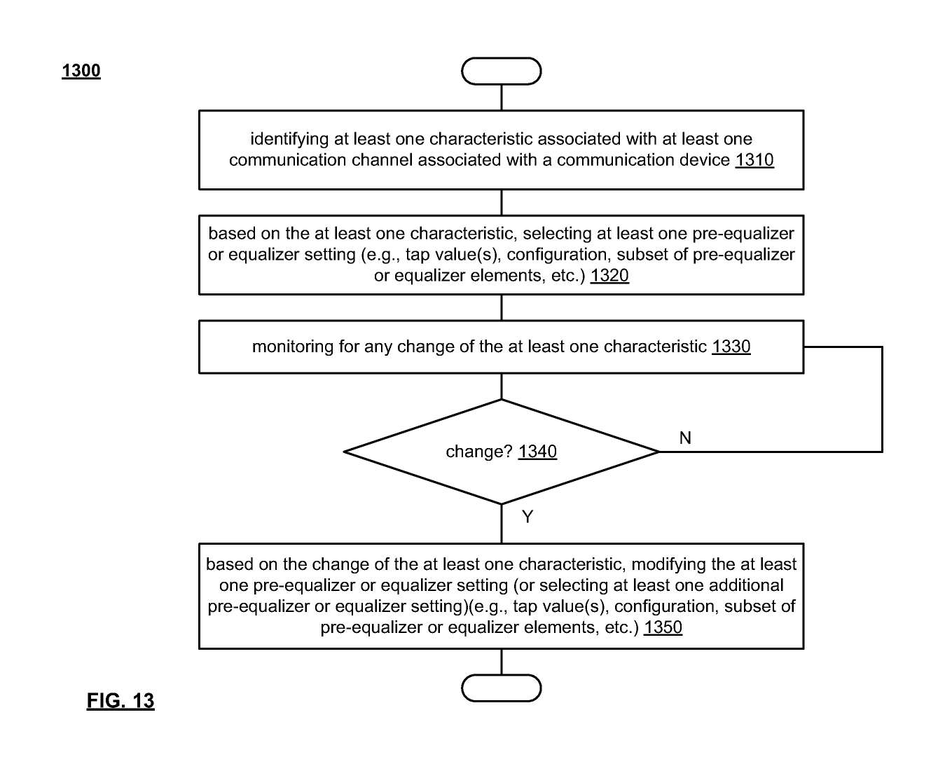

FIG. 10 illustrates an embodiment 1000 of multiple respective FIR filters each respectively employed one or more times in accordance with processing and/or equalization of one or more signals associated with a communication channel. The principles described above with respect to the previous diagram may generally be extended to employing any of a number of FIR filters successively such that each respective FIR filter may perform successive processing of respectively generated signals. The number of taps of each respective FIR filter in such an embodiment 1000 need not necessarily be the same, and the number of successive processing iterations performed by each respective FIR filter need not necessarily be the same. As may be understood, a great degree of flexibility may be provided by allowing for connectivity in connection of a number of respective FIR filters in any of a number of desired architectures or configurations.

Generally speaking, by employing different respective architectures of pre-equalizer or equalizer elements, application and distribution thereof may be made adaptively among a number of communication channels. The decision-making governing the dynamic and adaptive application of these pre-equalizer or equalizer elements to one or more respective communication channels may be based on any of a number of considerations, including but not limited to those described above.

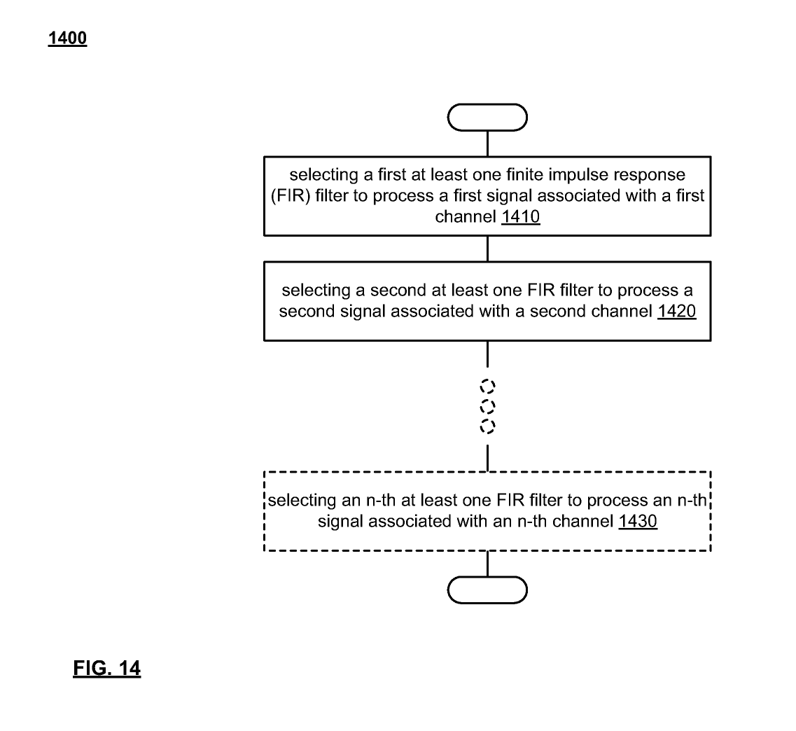

FIG. 11, FIG. 12, FIG. 13, and FIG. 14 illustrate various embodiments of methods for operating one or more communication devices.

Referring to method 1100 of FIG. 11, the method 1100 begins by operating at least one communication interface of a communication device to support communications with at least one communication device via a plurality of communication channels including receiving a plurality of signals corresponding respectively to the plurality of communication channels, as shown in a block 1110.

In certain embodiments, each of the plurality of signals may be implemented such that as they are corresponding to a respective one of the plurality of communication channels, as shown in a block 1112.

The method 1100 then operates by operating a plurality of equalizer elements adaptively connectable, in any of a plurality of configurations, to process the plurality of signals, including operating all of the plurality of equalizer elements or any subset of the plurality of equalizer elements to process at least one of the plurality of signals to generate a processed signal or a plurality of processed signals, as shown in a block 1120.

Referring to method 1200 of FIG. 12, the method 1200 begins by identifying at least one characteristic associated with at least one communication channel between a first communication device and a second communication device, as shown in a block 1210.

The method 1200 continues by selecting at least one pre-equalizer setting (e.g., tap values(s), configuration, subset of pre-equalizer elements, etc.)(e.g., in a transmitter/first communication device), as shown in a block 1220. The method 1200 then operates by selecting at least one equalizer setting (e.g., tap value(s), configuration, subset of equalizer elements, etc.)(e.g., in a receiver/second communication device), as shown in a block 1230. As may be understood with respect to some embodiments, the selecting operations associated with the blocks 1220 and 1230 may be based on the at least one characteristic as determined in the block 1210.

The method 1200 continues by supporting communications between the first communication device and the second communication device, as shown in a block 1240. Such communications are then supported and effectuated in accordance with such selected pre-equalizer setting and equalizer setting in the first communication device and the second communication device across one or more communication channels there between.

Referring to method 1300 of FIG. 13, the method 1300 begins by identifying at least one characteristic associated with at least one communication channel associated with a communication device, as shown in a block 1310. The method 1300 continues by based on the at least one characteristic, selecting at least one pre-equalizer or equalizer setting (e.g., tap value(s), configuration, subset of pre-equalizer or equalizer elements, etc.), as shown in a block 1320.

The method 1300 then operates by monitoring for any change of the at least one characteristic, as shown in a block 1330. Then, as shown in a decision block 1340, the method 1300 continues by determined whether or not any change has occurred. If no change has been detected as having occurred, then the method 1300 continues operations with respect to the block 1330.

Alternatively, if a change has been detected as having occurred, then based on the change of the at least one characteristic, the method 1300 continues by modifying the at least one pre-equalizer or equalizer setting (or selecting at least one additional pre-equalizer or equalizer setting)(e.g., tap value(s), configuration, subset of pre-equalizer or equalizer elements, etc.), as shown in a block 1350.

Referring to method 1400 of FIG. 14, the method 1400 begins by selecting a first at least one finite impulse response (FIR) filter to process a first signal associated with a first channel, as shown in a block 1410. This may be as few as one selected FIR filter or any subset of the FIR filters (e.g., two or more FIR filters which may include all FIR filters in some embodiments).

The method 1400 continues by selecting a second at least one FIR filter to process a second signal associated with a second channel, as shown in a block 1420. Again, with operations associated with this block and any others, it is noted that this may be as few as one selected FIR filter or any subset of the FIR filters (e.g., two or more FIR filters which may include all FIR filters in some embodiments). Such similar operations and/or processes may be performed as described with respect to the operations of the blocks 1410 and 1420 (e.g., any number of times such as including second at least one FIR filter to process a second signal associated with a second channel).

The method 1400 then operates by selecting an n-th at least one FIR filter to process an n-th signal associated with an n-th channel, as shown in a block 1430.

It is also noted that the various operations and functions as described with respect to various methods herein may be performed within any of a number of types of communication devices, such as using a baseband processing module and/or a processing module implemented therein, and/or other components therein. For example, such a baseband processing module and/or processing module can generate such signals and perform such operations, processes, etc. as described herein as well as perform various operations and analyses as described herein, or any other operations and functions as described herein, etc. or their respective equivalents.

In some embodiments, such a baseband processing module and/or a processing module (which may be implemented in the same device or separate devices) can perform such processing, operations, etc. in accordance with various aspects of the invention, and/or any other operations and functions as described herein, etc. or their respective equivalents. In some embodiments, such processing is performed cooperatively by a first processing module in a first device, and a second processing module within a second device. In other embodiments, such processing, operations, etc. are performed wholly by a baseband processing module and/or a processing module within one given device. In even other embodiments, such processing, operations, etc. are performed using at least a first processing module and a second processing module within a singular device.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction with software, and/or firmware. As used herein, a module may contain one or more sub-modules that themselves are modules.

While particular combinations of various functions and features of the present invention have been expressly described herein, other combinations of these features and functions are likewise possible. The present invention is not limited by the particular examples disclosed herein and expressly incorporates these other combinations.

What is claimed is:

1. An apparatus, comprising:
at least one communication interface to support communications with at least one communication device via a plurality of communication channels including to receive a plurality of signals corresponding respectively to the plurality of communication channels such that each of the plurality of signals corresponding to a respective one of the plurality of communication channels; and
a plurality of equalizer elements adaptively connectable, in any of a plurality of configurations, to process the plurality of signals, wherein all of the plurality of equalizer elements or any subset of the plurality of equalizer elements to process at least one of the plurality of signals to generate a processed signal or a plurality of processed signals;
a processor to perform a least means square (LMS) optimization process to select a plurality of equalizer tap coefficients corresponding to at least one of the plurality of equalizer elements based on at least one characteristic associated with at least one of the plurality of communication channels; and wherein:
the at least one characteristic corresponding to at least one of latency, delay, noise, distortion, crosstalk, attenuation, signal to noise ratio (SNR), capacity, bandwidth, frequency spectrum, bit rate, and symbol rate associated with at least one the plurality of communication channels.

2. The apparatus of claim 1, wherein:
at least one of the plurality of equalizer elements to process a first of the plurality of signals to generate a first processed signal and to process the first processed signal to generate a second processed signal.

3. The apparatus of claim 1, further comprising:
the at least one communication device including a transmitter communication device; and wherein:
the transmitter communication device including a plurality of pre-equalizer elements adaptively connectable, in any of at least one additional plurality of configurations, to process at least one additional plurality of signals to generate the plurality of signals for transmission to the apparatus.

4. The apparatus of claim 3, further comprising:
at least one processor to select one of the plurality of configurations by which the plurality of equalizer elements are connected in conjunction with one of the at least one additional plurality of configurations by which the plurality of pre-equalizer elements are connected based on at least one characteristic associated with the plurality of communication channels; and wherein:
the at least one characteristic corresponding to at least one of latency, delay, noise, distortion, crosstalk, attenuation, signal to noise ratio (SNR), capacity, bandwidth, frequency spectrum, bit rate, and symbol rate associated with the plurality of communication channels.

5. The apparatus of claim 1, wherein:
the apparatus being a communication device operative within at least one of a satellite communication system, a wireless communication system, a wired communication system, a fiber-optic communication system, and a mobile communication system.

6. An apparatus, comprising:
at least one communication interface to support communications with at least one communication device via a plurality of communication channels including to receive a plurality of signals corresponding respectively to the plurality of communication channels such that each of the plurality of signals corresponding to a respective one of the plurality of communication channels; and
a plurality of equalizer elements adaptively connectable, in any of a plurality of configurations, to process the plurality of signals, wherein all of the plurality of equalizer elements or any subset of the plurality of equalizer elements to process at least one of the plurality of signals to generate a processed signal or a plurality of processed signals.

7. The apparatus of claim 6, wherein:
at least one of the plurality of equalizer elements to process a first of the plurality of signals to generate a first processed signal and to process the first processed signal to generate a second processed signal.

8. The apparatus of claim 6, wherein:
the plurality of equalizer elements to process the plurality of signals to generate the plurality of processed signals and to process the plurality of processed signals to generate at least one additional plurality of processed signals.

9. The apparatus of claim 6, further comprising:
a processor to perform a least means square (LMS) optimization process to select a plurality of equalizer tap coefficients corresponding to at least one of the plurality of equalizer elements.

10. The apparatus of claim 6, further comprising:
a processor to select a plurality of equalizer tap coefficients corresponding to at least one of the plurality of equalizer elements based on at least one characteristic associated with at least one of the plurality of communication channels; and wherein:
the at least one characteristic corresponding to at least one of latency, delay, noise, distortion, crosstalk, attenuation, signal to noise ratio (SNR), capacity, bandwidth, frequency spectrum, bit rate, and symbol rate associated with at least one the plurality of communication channels.

11. The apparatus of claim 6, further comprising:
the at least one communication device including a transmitter communication device; and wherein:
the transmitter communication device including a plurality of pre-equalizer elements adaptively connectable, in any of at least one additional plurality of configurations, to process at least one additional plurality of signals to generate the plurality of signals for transmission to the apparatus.

12. The apparatus of claim 11, further comprising:
at least one processor to select one of the plurality of configurations by which the plurality of equalizer elements are connected in conjunction with one of the at least one additional plurality of configurations by which the plurality of pre-equalizer elements are connected based on at least one characteristic associated with the plurality of communication channels; and wherein:
the at least one characteristic corresponding to at least one of latency, delay, noise, distortion, crosstalk, attenuation, signal to noise ratio (SNR), capacity, bandwidth, frequency spectrum, bit rate, and symbol rate associated with the plurality of communication channels.

13. The apparatus of claim 6, wherein:
the apparatus being a communication device operative within at least one of a satellite communication system, a wireless communication system, a wired communication system, a fiber-optic communication system, and a mobile communication system.

14. A method for operating a communication device, the method comprising:
operating at least one communication interface to support communications with at least one communication device via a plurality of communication channels including receiving a plurality of signals corresponding respectively to the plurality of communication channels such that each of the plurality of signals corresponding to a respective one of the plurality of communication channels; and
operating a plurality of equalizer elements adaptively connectable, in any of a plurality of configurations, to process the plurality of signals, including operating all of the plurality of equalizer elements or any subset of the plurality of equalizer elements to process at least one of the plurality of signals to generate a processed signal or a plurality of processed signals.

15. The method of claim 14, further comprising:
operating at least one of the plurality of equalizer elements to process a first of the plurality of signals to generate a first processed signal and to process the first processed signal to generate a second processed signal.

16. The method of claim 14, further comprising:
performing a least means square (LMS) optimization process to select a plurality of equalizer tap coefficients corresponding to at least one of the plurality of equalizer elements.

17. The method of claim 14, further comprising:
selecting a plurality of equalizer tap coefficients corresponding to at least one of the plurality of equalizer elements based on at least one characteristic associated with at least one of the plurality of communication channels, wherein the at least one characteristic corresponding to at least one of latency, delay, noise, distortion, crosstalk, attenuation, signal to noise ratio (SNR), capacity, bandwidth, frequency spectrum, bit rate, and symbol rate associated with at least one the plurality of communication channels.

18. The method of claim 14, further comprising:
operating at least one additional communication device, including a plurality of pre-equalizer elements adaptively connectable, in any of at least one additional plurality of configurations, to process at least one additional plurality of signals to generate the plurality of signals for transmission to the communication device.

19. The method of claim 18, further comprising:
selecting one of the plurality of configurations by which the plurality of equalizer elements are connected in conjunction with one of the at least one additional plurality of configurations by which the plurality of pre-equalizer elements are connected based on at least one characteristic associated with the plurality of communication channels, wherein the at least one characteristic corresponding to at least one of latency, delay, noise, distortion, crosstalk, attenuation, signal to noise ratio (SNR), capacity, bandwidth, frequency spectrum, bit rate, and symbol rate associated with the plurality of communication channels.

20. The method of claim 14, wherein:
the communication device operative within at least one of a satellite communication system, a wireless communication system, a wired communication system, a fiber-optic communication system, and a mobile communication system.
